(19) United States
(12) Patent Application Publication
(10) Pub. No.: US 2014/0374952 A1
(43) Pub. Date: Dec. 25, 2014

(54) SOUND ABSORBING WALL

(71) Applicant: William Lee Bergiadis, Santa Clarita, CA (US)

(72) Inventor: William Lee Bergiadis, Santa Clarita, CA (US)

(21) Appl. No.: 14/480,119

(22) Filed: Sep. 8, 2014

Related U.S. Application Data
(63) Continuation of application No. 13/368,577, filed on Feb. 8, 2012, now abandoned.

(51) Int. Cl. E01F 8/00; E04B 1/84; B28B 23/02; B28B 1/14; B28B 23/00; E04B 1/82; E04C 2/06

(52) U.S. Cl. CPC E01F 8/0005; E04B 1/8227; E04B 1/84; E04C 2/06; B28B 1/14; B28B 23/005; B28B 23/02
USPC 264/261; 52/745.1

(57) ABSTRACT

Sound absorbing walls include a planar front panel element formed of an acoustically transmissive material and having a peripheral edge, a planar inner panel element formed of an acoustically absorbent material, having a peripheral edge, a front face abutting the front panel, and an opposed rear face, and a rigid frame having a panel portion overlaying the rear face of the inner panel element, and having a peripheral edge, and an edge portion forming a rim depending from the peripheral edge of the frame, and enclosing the peripheral edges of the front panel and inner panel. The frame may encapsulate the front panel and inner panel, except for an exposed front panel front surface. The rim may extend forward of the front panel. A sound wall may be constructed by connecting edge portions of one or more panels to spaced apart first and second ground-mounted vertical support columns.

### REFERENCE TO RELATED APPLICATION

This is a Continuation of U.S. patent application Ser. No. 13/368,577, filed Feb. 8, 2012, entitled “SOUND ABSORBING WALL.”

### FIELD OF THE INVENTION

The present invention relates to walls for reducing highway noise, and to sound-absorbing elements.

### BACKGROUND OF THE INVENTION

Highway sound walls are used to decrease the volume of highway sound experienced by residences and businesses located nearby. Current concrete highway sound walls suffer the disadvantage of reflecting highway sounds in the opposite direction. The reflection or reverberation causes the highway sound level to persist longer, thus adding to the overall volume. In addition, the reflected sounds from one wall can be refracted over the opposing wall. Refraction around the edges of concrete walls reduces the walls' sound-lowering benefit significantly.

In other noise-reduction applications, sound absorbing materials are used effectively. However, most sound absorbing materials are not suitable for use outdoors. Foam and fiberglass are damaged by rain, and rubber is degraded by ultraviolet light and freeze/thaw cycles. These and other absorbent materials are also vulnerable to animal damage and vandalism.

Therefore, a need exists for a new and improved sound absorbing wall that absorbs highway sound without any reflection, thus reducing refraction. In this regard, the various embodiments of the present invention substantially fulfill at least some of these needs. In this respect, the sound absorbing wall according to the present invention substantially departs from the conventional concepts and designs of the prior art, and in doing so provides an apparatus primarily developed for the purpose of absorbing highway sound without any reflection and significantly reducing refraction.

### SUMMARY OF THE INVENTION

The present invention provides an improved sound absorbing wall, and overcomes the above-mentioned disadvantages and drawbacks of the prior art. As such, the general purpose of the present invention, which will be described subsequently in greater detail, is to provide an improved sound absorbing wall that has all the advantages of the prior art.

To attain this, the preferred embodiment of the present invention essentially comprises a planar front panel element formed of an acoustically transmissive material and having a peripheral edge, a planar inner panel element formed of an acoustically absorbent material, having a peripheral edge, a front face abutting the front panel, and an opposed rear face, and a rigid frame having a panel portion overlaying the rear face of the inner panel element, and having a peripheral edge, and an edge portion forming a rim depending from the peripheral edge of the frame, and enclosing the peripheral edges of the front panel and inner panel. The frame may encapsulate the front panel and inner panel, except for an exposed front panel front surface. The rim may extend forward of the front panel. A sound wall may be constructed by connecting edge portions of one or more panels to spaced apart first and second ground-mounted vertical support columns. There are, of course, additional features of the invention that will be described hereinafter and which will form the subject matter of the claims attached.

There has thus been outlined, rather broadly, the more important features of the invention in order that the detailed description thereof that follows may be better understood and in order that the present contribution to the art may be better appreciated.

### BRIEF DESCRIPTION OF THE DRAWINGS

FIG. 1 is a front perspective view of the current embodiment of the panel constructed in accordance with the principles of the present invention.

FIG. 2 is a rear view of the current embodiment of the panel.

FIG. 3 is a rear perspective view of the current embodiment of the sound absorbing wall constructed in accordance with the principles of the present invention.

FIG. 4 is a cross-section view taken along the line 4-4 of FIG. 3.

FIG. 5 is a left side sectional view of the current embodiment of the panel with concrete forms in place.

The same reference numerals refer to the same parts throughout the various figures.

### DESCRIPTION OF THE CURRENT EMBODIMENT

A preferred embodiment of the sound absorbing wall of the present invention is shown and generally designated by the reference numeral 10.

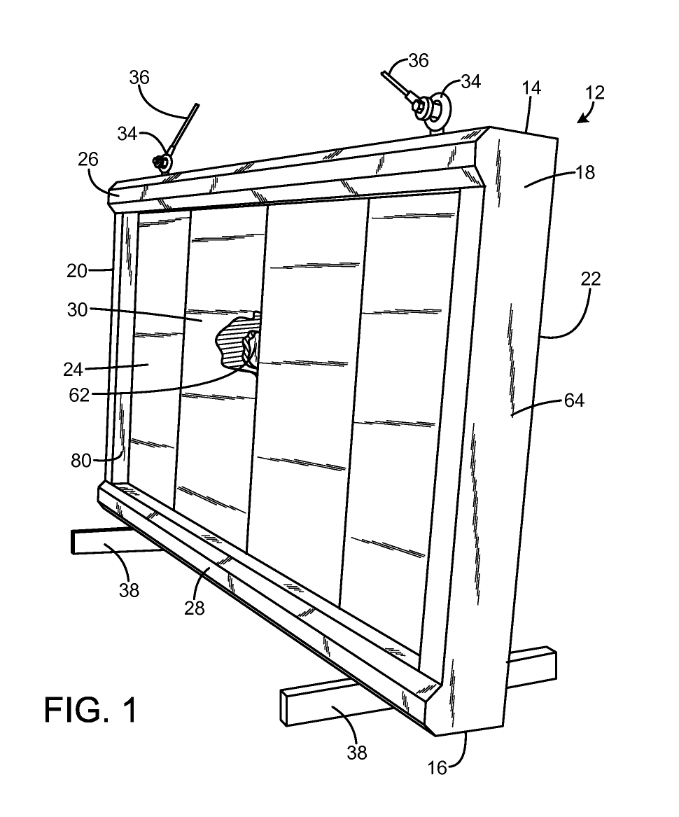

FIG. 1 illustrates the improved panel 12 of the present invention. More particularly, the panel has a concrete frame 64 having a top 14, a bottom 16, a right side 18, a left side 20, a rear 22, and a front 24. The front of the frame defines a recess 80 that receives a panel board layer 30. An optional perforated and paintable metal screen (not shown) can be attached to cover the exposed panel board layer The top front of the frame defines a chamfered edge 26, and the bottom front of the frame defines a chamfered edge 28. In the current embodiment, the frame is made of concrete, and the panel board layer is made of wood fibers having a typical length of 12″ and width of 3 mm and Portland cement. The panel board layer is 4″ thick in the current embodiment.

The panel 12 is depicted in completed form prior to installation in a sound absorbing wall 10. The top 14 of the panel has lifting eyes 34 that are screwed into molded insets in the top. These are connected to a cable 36 so the panel can be raised into place. The panel rests on temporary wooden supports 38 prior to being lifted.

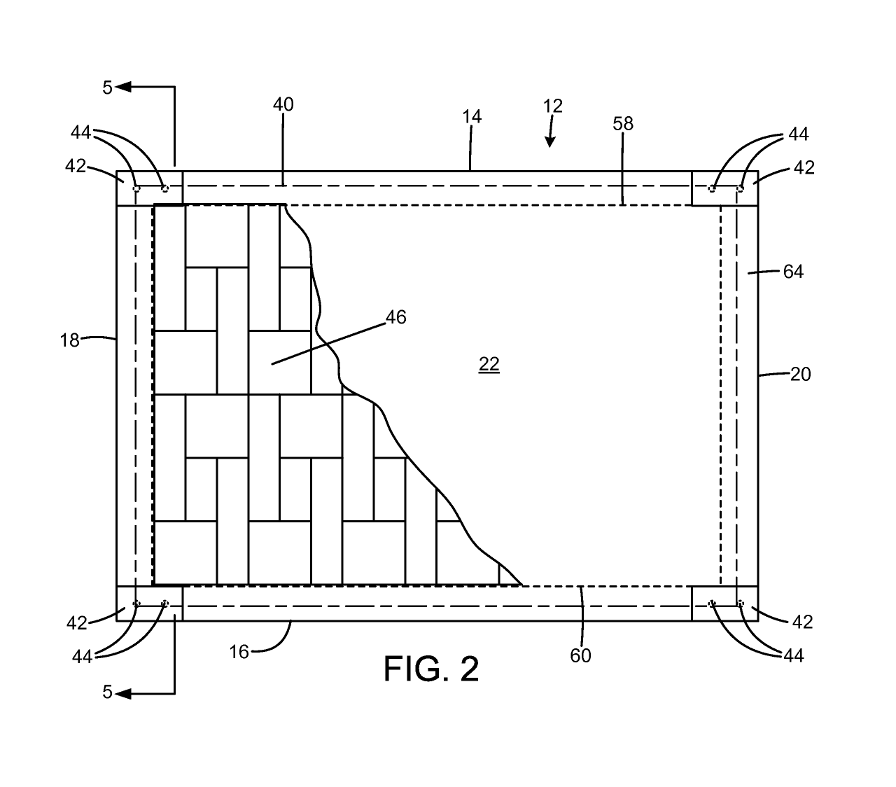

FIG. 2 illustrates the rear 22 of the panel 12 of FIG. 1. More particularly, the concrete frame 64 can have a pattern 46 cast into the front to create a decorative appearance. The pattern terminates at the edges of the chamfer 58, 60. A structurally engineered design of rebar 40 is positioned within the frame to reinforce and strengthen the frame. Two-headed steel pins 44 are embedded in each of the corners of the frame to secure weld plates 42 to the front corners of the frame. In the current embodiment, the weld plates are made of steel.

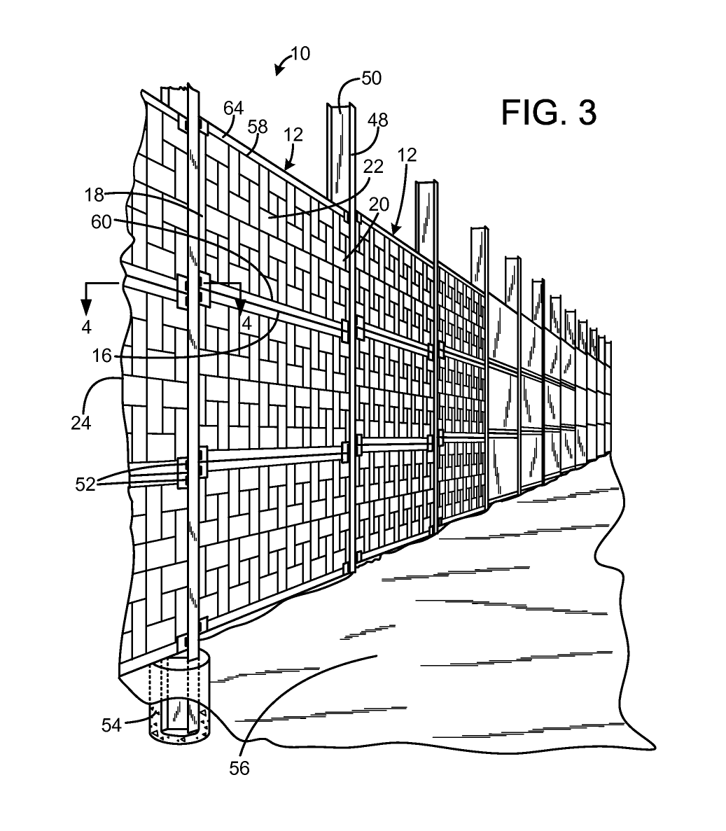

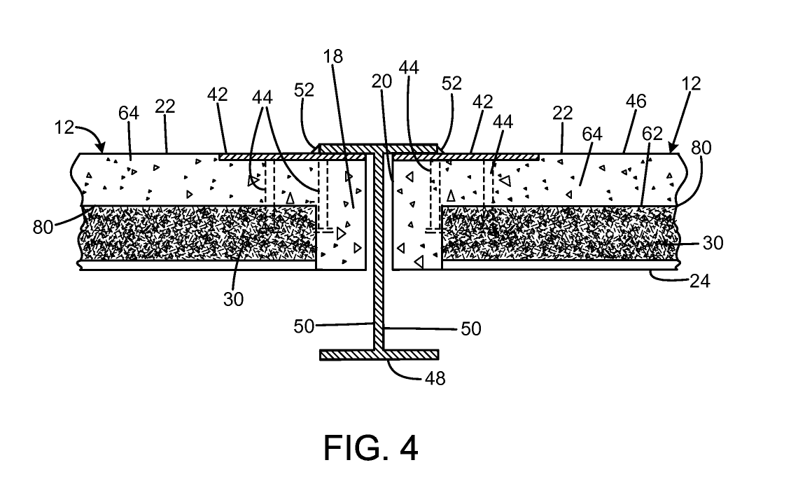

FIGS. 3 and 4 illustrate the improved sound absorbing wall 10 of the present invention. More particularly, the sound absorbing wall 10 consists of one or more panels 12 mounted on two or more I-beams 48. Each panel, which can be lifted by a 3 ton crane, has its left 18 and right 20 sides inserted into slots 50 in adjacent I-beams. The panel is secured in place by welding the panel's weld plates 42 to the flanges of the I-beams, which suspends the panel from the vertical I-beams as point loads. The panels do not place any load upon panels located below. As a result, the sound absorbing wall does not require a horizontal footing. Furthermore, the structural shear value of the entire wall is increased, which prevents the wall from toppling during extreme wind conditions or earthquakes.

Each panel 12 is about 4′6″ wide and 12′ long. Each I-beam 48 is embedded in a 24″ drilled hole 54 that extends below grade 56. In the current embodiment, the I-beams are W12×30@12′3″ OC., the drilled hole is about 24″ in diameter, at least 12′ long, and filled with 2500 psi concrete, about 11′6″ of the I-beam is enclosed by the concrete, and at most 18′ of the I-beam extends above grade. Each panel is positioned with its front facing sources of highway sound. As a result, highway sound is almost completely absorbed by the panel board 30 and not reflected (approximately 89% of the sound is absorbed), while the surrounding frame provides structural stability and durability. In one application, sound levels measured 125 feet from the wall and 12 feet above the base of the wall were reduced from above 96 dBA to below 64 dBA. The decibel reduction occurred despite only 6 feet of the 18 foot wall actually protecting the sound measurement location.

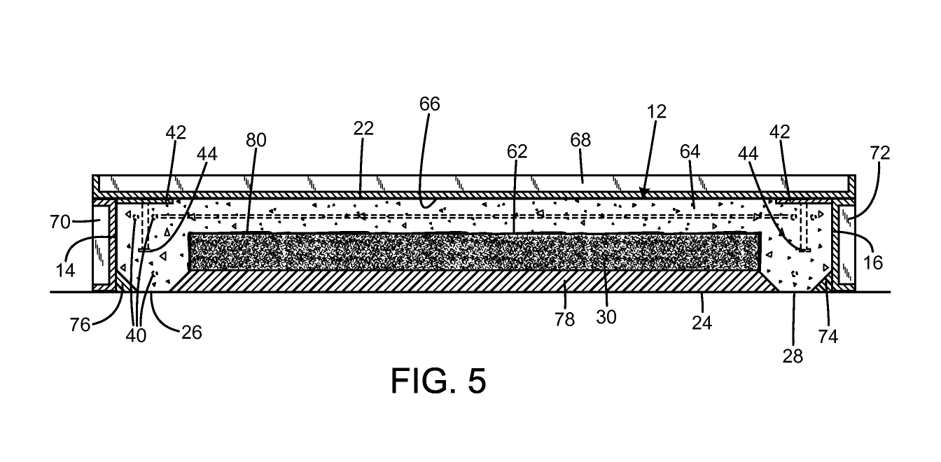

FIG. 5 illustrates the improved panel 10 of FIG. 1 with concrete forms in place. More particularly, the panel 12 is capable of being cast on site, which eliminates expensive transportation of completed panels. The concrete forms consist of an upper form 68, outer forms 70 and 72, and spacer forms 74, 76, and 78. In the current embodiment, the forms 68, 70, 72 are aluminum frames and the forms 74, 76, 78 are made of foam or wood laminate material. The upper form has a pattern 66 on it that forms the pattern 46 on the rear 22 of the finished panel.

To make a panel 12, first the outer forms 70, 72 are connected together to define the outer edges of the panel. Subsequently, the spacer forms 74, 76, and 78 are positioned to form the chamfered edges 26, 28 and to provide an elevated surface so the panel board 30 is flush with the chamfered edges when laid in position over the spacer form 78, with the board resting on the spacer so that it is encapsulated by the concrete behind the board. Next, the rebar 40 is suspended from the outer forms above the plastic layer. A portion of the rebar suspends the weld plates 42 so the weld plates will be flush with the rear 22 surface of the panel. The headed pins 44 are suspended from the weld plates. Finally, concrete is poured over the rebar and the upper form 68 is laid over the outer frames to define the rear surface of the finished panel.

In the finished panel, the sound absorbing function is encapsulated on one face and all peripheral edges by the concrete and on the front face by the board, which functions essentially as if it were acoustically transparent in the frequencies sought to be absorbed. In alternative embodiments, the board may be covered by other durable perforated material that is cast into the concrete frame, such as perforated or expanded metal, thus allowing the absorption of sound to occur.

While a current embodiment of the sound absorbing wall has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, although positioning each panel with its front facing sources of highway sound has been described, it should be appreciated that the absorptive side of the panel can also be positioned facing away from sources of highway sound. This placement reflects more noise to the other side of the highway, but further lowers the level of sound on the other side of the wall.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of forming an acoustically absorbent panel comprising the steps:
obtaining outer forms;
obtaining spacer forms;
obtaining an upper form;
obtaining a panel board;
obtaining rebar;
obtaining weld plates;
connecting together the outer forms to define a space;
positioning the spacer forms within the space defined by the outer forms to define a peripheral gap between the spacer forms and the outer forms;
placing the panel board on top of one of the spacer forms to define a peripheral gap between the panel board and the outer forms;
positioning the rebar above the panel board;
positioning the weld plates adjacent to the rebar;
pouring concrete over the rebar until the space defined by the outer forms is filled;
placing the upper form over the outer forms;
waiting for the concrete to cure; and
removing the upper form, outer forms, and spacer forms from the panel board and the cured concrete to expose a finished acoustically absorbent panel.

2. The method of claim 1 wherein the upper form has a pattern on a portion that contacts the concrete such that a pattern is formed on the finished acoustically absorbent panel.

3. The method of claim 1 wherein the spacer forms have a shape selected from the group consisting of elongated triangular prisms and elongated trapezoidal prisms such that the spacer forms cause the cured concrete to form chamfered edges.

4. The method of claim 3 wherein the spacer form the panel board is placed on top of has a height sufficient to locate a surface of the panel board flush with the chamfered edges of the cured concrete.

5. The method of claim 1 wherein the panel board is made of a blend of Portland cement and wood fibers having a length of 12 inches and a width of 3 mm.

6. The method of claim 1 wherein the weld plates are made of steel.

7. The method of claim 1 wherein the weld plates are located at four corners of the finished acoustically absorbent panel.

8. The method of claim 1 wherein the weld plates are positioned at a height sufficient to locate a surface of the weld plates flush with a rear surface of the cured concrete.

9. The method of claim 1 further comprising the steps of obtaining headed pins and positioning the headed pins adjacent to the weld plates occurring before the step of pouring concrete over the rebar until the space defined by the outer forms is filled.

10. A method of assembling an acoustically absorbent wall comprising the steps:
obtaining a first acoustically absorbent panel having opposed sides and weld plates on a surface;
obtaining at least two support posts having opposed ends and flanges;
drilling at least two holes in the ground;
inserting one of the opposed ends of each of the support posts into each of the holes;
filling the holes to provide lateral support to the support posts;
positioning the first acoustically absorbent panel at a desired height between the support posts; and
welding the weld plates on the first acoustically absorbent panel to the support posts such that the first acoustically absorbent panel is secured to the support posts as a point load and the first acoustically absorbent panel only places a load on the ground via transmission via the support posts.

11. The method of claim 10 wherein the holes are filled with concrete.

12. The method of claim 10 wherein the support posts are I-beams.

13. The method of claim 10 wherein at least one-third of the support posts' length is in the hole.

14. The method of claim 10 wherein each of the support posts defines a vertical channel, and further comprising the steps of lifting the first acoustically absorbent panel above the exposed ends of the support posts and inserting the opposed sides of the first acoustically absorbent panel into the vertical channels of the support posts occurring before the step of positioning the first acoustically absorbent panel at a desired height between the support posts and after the step of filling the holes to provide lateral support to the support posts.

15. The method of claim 14 wherein the support posts are inserted into the holes such that their vertical channels face each other.

16. The method of claim 10 wherein the weld plates and support posts are made of steel.

17. The method of claim 10 wherein the weld plates are located on a rear surface of the first acoustically absorbent panel.

18. The method of claim 10 wherein the first acoustically absorbent panel has a panel board encapsulated by a concrete frame.

19. The method of claim 10 further comprising the steps:
obtaining a second acoustically absorbent panel having opposed sides and weld plates on a surface;
positioning the second acoustically absorbent panel at a desired height between the support posts; and
welding the weld plates on the second acoustically absorbent panel to the support posts such that the second acoustically absorbent panel is secured to the support posts as a point load and the second acoustically absorbent panel does not place a load on the first acoustically absorbent panel.

20. The method of claim 20 wherein each of the support posts defines a vertical channel, and further comprising the steps of lifting the second acoustically absorbent panel above the exposed ends of the support posts and inserting the opposed sides of the second acoustically absorbent panel into the vertical channels of the support posts occurring before the step of positioning the second acoustically absorbent panel at a desired height between the support posts and after the step of obtaining a second acoustically absorbent panel having opposed sides and weld plates on a surface.
